(19) United States
(12) Patent Application Publication
(10) Pub. No.: US 2012/0059817 A1
(43) Pub. Date: Mar. 8, 2012

(54) METHOD FOR INCREASING THE EFFICIENCY OF SYNCHRONIZED SCANS THROUGH INTELLIGENT QUERY DISPATCHING

(75) Inventors: Louis M. Burger, Escondido, CA (US); Thomas P. Julien, San Diego, CA (US); Douglas P. Brown, Rancho Santa Fe, CA (US)

(73) Assignee: TERADATA US, INC., Miamisburg, OH (US)

(21) Appl. No.: 12/876,373

(22) Filed: Sep. 7, 2010

(51) Int. Cl. G06F 17/30

(52) U.S. Cl. 707/718; 707/E17.017

(57) ABSTRACT

A computer-implemented method, apparatus and article of manufacture for optimizing execution of database queries in a computer system. In one embodiment, the steps and functions include: generating first and second query execution plans for first and second requests, wherein the first and second query execution plans are each comprised of one or more steps that scan a specified table in a database stored on the computer system in order to retrieve data from the table; and executing the first and second query execution plans, wherein intelligent query dispatching is performed on the steps of the first and second query execution plans to ensure that the steps share the data retrieved from the table and cached in memory.

### BACKGROUND OF THE INVENTION

1. Field of the Invention

The invention relates generally to computer-implemented database systems, and specifically, to query optimization for relational database management systems.

2. Description of the Related Art

Prior art query optimizers typically rely upon a cost model to choose the best query execution plan for any given query. In most optimizers, alternative query execution plans are generated for a given query and the optimizer selects the optimal query plan, which may be the most cost-effective execution plan or one of the more cost-effective execution plans. The optimizer identifies an execution plan (query plan, join plan, or strategy) that reduces the estimated response time of a given query. The response time is the amount of time it takes to complete the execution of the query on the given target system.

However, prior art optimizers fail to consider the impact of run-time (real-time) system conditions and operating environment events may have on query optimization. For example, the commercial database products offered by Teradata Corporation, the assignee of the present invention, provide a performance optimization wherein concurrent queries performing full or partial table scan share physical I/Os to data storage devices such as disk drives storing the rows of the table. This feature is known as a synchronized scan or “Sync Scan,” and can result in dramatic performance savings and lower utilization of system resources.

In one embodiment, the implementation of Sync Scan provided by the database management system is quite sophisticated in that it does not require the two synchronized scans to read their shared data linearly from beginning to end. A given scan can join another scan already in progress. In addition, recently read data blocks are cached in memory to allow scans with different row processing speeds to perform logical I/Os to the memory at different times while still sharing physical I/Os to the disks. The database management system periodically monitors synchronized scans to determine if they are still sufficiently close enough together to keep the necessary data in cache and if not the Sync Scan is abandoned.

The overall effectiveness and efficiency from Sync Scan is maximized when eligible table scans are executed concurrently in the system. Concurrency impacts the decision to initiate Sync Scan as well as the amount of overlap between synchronized scans where “overlap” denotes that portion of the table in which physical I/Os are shared.

The term “Sync Scan Efficiency” is defined to denote the amount of overlap between two eligible table scans using the Sync Scan performance optimization. Two eligible scans that employ Sync Scan and that overlap for half of the physical I/Os to perform a single scan have a 50% Sync Scan Efficiency. Using a simple example, two overlapping scans with a 25% Sync Scan Efficiency will do 75% more physical I/O to satisfy the both scans than two overlapping scans with 100% Sync Scan Efficiency. In general, less system resources are required as Sync Scan Efficiency approaches 100%.

Currently, the consideration and control of Sync Scan is primarily limited to the file system layer of the database management system. Participation of higher level layers or components of the database management system is limited to a decision made by a query optimizer function of the database management system of whether a table is sufficiently large enough to warrant the potential use of Sync Scan. No attempt is made to intentionally schedule and execute Sync Scan eligible plan steps (from different queries) such that their concurrency is maximized. As a result, from the standpoint of query scheduling, the opportunity to employ Sync Scan and the degree of Sync Scan Efficiency is to some degree a matter of blind luck.

Therefore, there is a need in the art for query optimizations that occur during runtime that are “Sync Scan” aware, so that Sync Scan opportunities can be identified and Sync Scan efficiency can be increased. The present invention satisfies this need using intelligent query scheduling as described in more detail below.

### SUMMARY OF THE INVENTION

To overcome the limitations in the prior art described above, and to overcome other limitations that will become apparent upon reading and understanding the present specification, the present invention discloses a computer-implemented method, apparatus, and article of manufacture for optimizing execution of database queries in a computer system.

In one embodiment, the steps and functions include: generating first and second query execution plans for first and second requests, wherein the first and second query execution plans are each comprised of one or more steps that scan a specified table in a database stored on the computer system in order to retrieve data from the table; and executing the first and second query execution plans, wherein intelligent query dispatching is performed on the steps of the first and second execution plans to ensure that the steps share the data retrieved from the table and cached in memory.

The steps of the second execution plan may access the data cached in the memory at a location different from the steps of the first execution plan. Moreover, the steps of the second execution plan may access the data cached in the memory at a processing speed different from the steps of the first execution plan.

The intelligent query dispatching coordinates execution of the steps of the first and second execution plans so that the steps execute concurrently. In one embodiment, the intelligent query dispatching delays the steps of the first or second execution plans in order to coordinate the execution of the steps of the first and second execution plans. For example, the intelligent query dispatching may fully delay the steps of the first or second execution plans, so that the steps of the first and second execution plans begin execution at substantially the same time. In another example, the intelligent query dispatching may partially delay the steps of the first or second execution plans, so that the steps of the first and second execution plans overlap during execution. In either instance, the intelligent query dispatching delays the steps of the first or second execution plans without negatively affecting a response time for the first or second requests.

Other features and advantages will become apparent from the description and claims that follow.

### BRIEF DESCRIPTION OF THE DRAWINGS

Referring now to the drawings in which like reference numbers represent corresponding parts throughout:

FIG. 1 is a block diagram of a node of a database system.

FIG. 2 is a block diagram of a parsing engine.

FIG. 3 is a flow chart of a parser.

FIGS. 4-7 are block diagrams of a system for administering the workload of a database system.

FIG. 8 is a flow chart of intelligent query dispatching.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Hardware and Software Environment

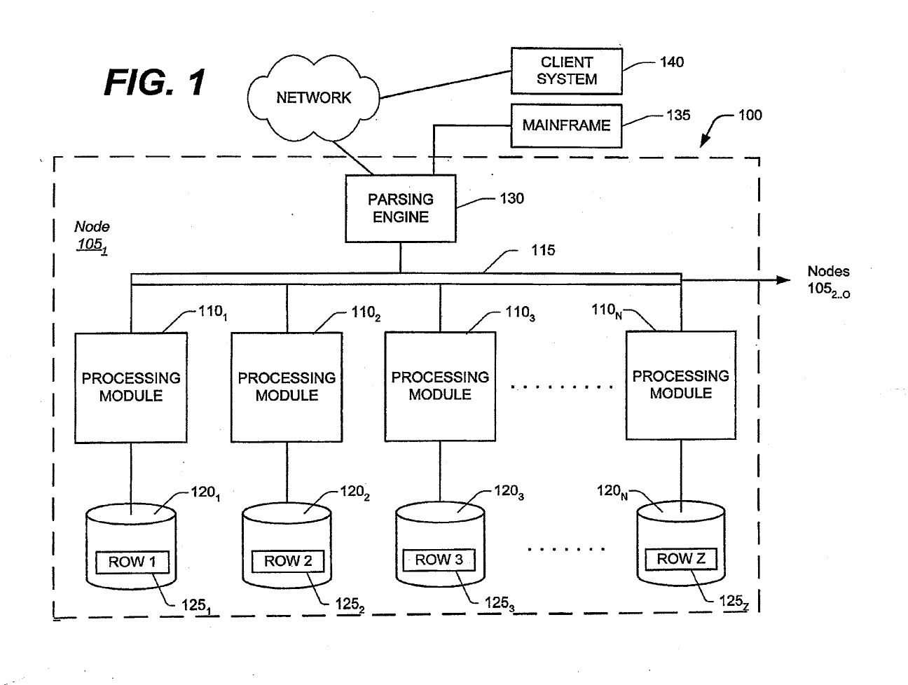

FIG. 1 is a schematic illustration of an exemplary hardware and software environment for the present invention. The exemplary hardware and software environment comprises a database system (“DBS”) 100, such as a Teradata Active Data Warehouse (ADW) available from Teradata Corporation that is used to manage very large databases.

The DBS 100 is comprised of one or more nodes 105_{1, 2 . . . O} of the DBS 100 connected by a network 115. The DBS 100 may include multiple nodes 105_{2 . . . N} in addition to the illustrated node 105₁, connected by extending the network 115.

The DBS node 105₁ includes one or more processing modules 110_{1 . . . N}, connected by a network 115 that manage the storage and retrieval of data in data storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors. Each virtual processor is generally termed an Access Module Processor (AMP) in the Teradata Active Data Warehousing System.

For the case in which N virtual processors are running on an M processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data storage facilities 120_{1 . . . N}. Each of the data storage facilities 120_{1 . . . N} includes one or more disk drives.

The system stores data in one or more tables in the data storage facilities 120_{1 . . . N}. The rows 125_{1 . . . Z} of the tables are stored across multiple data storage facilities 120_{1 . . . N} to ensure that the system workload is distributed evenly across the processing modules 110_{1 . . . N}.

A Parsing Engine (PE) 130 organizes the storage of data and the distribution of table rows 125_{1 . . . Z} among the processing modules 110_{1 . . . N}. The PE 130 also coordinates the retrieval of data from the data storage facilities 120_{1 . . . N} in response to queries received from a user at a mainframe 135 or a client computer 140. The DBS 100 usually receives queries in a standard format, such as SQL.

Parsing Engine

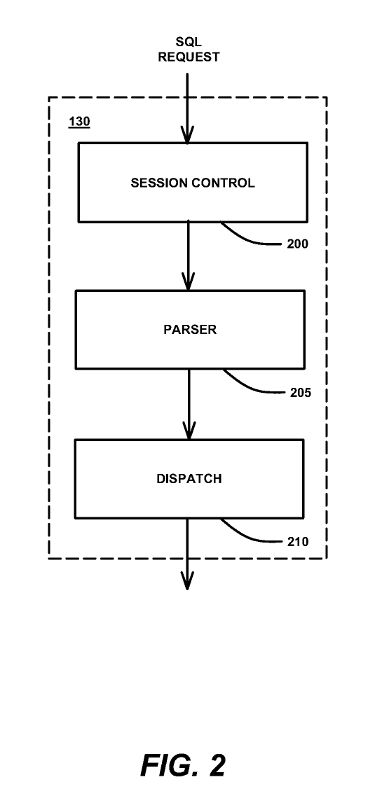

FIG. 2 is a block diagram that illustrates the primary components of the PE 130: a session control 200, a parser 205, and a dispatch function 210.

The session control 200 provides the logon and logoff function. It accepts a request for authorization to access the database, verifies it, and then either allows or disallows the access.

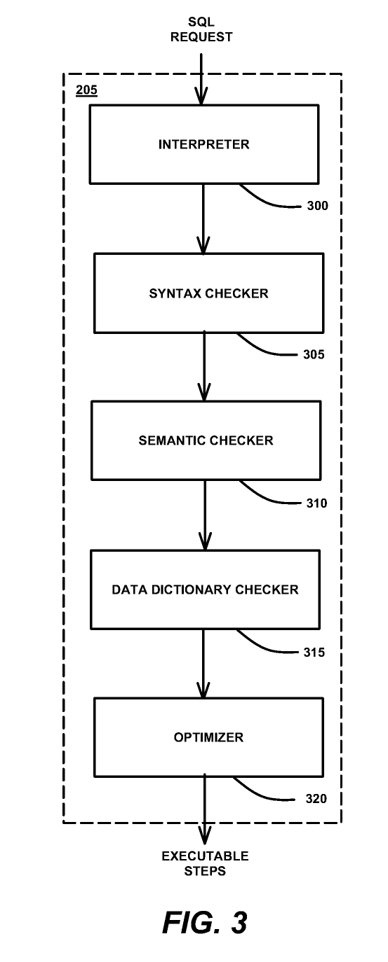

Once the session control 200 allows a session to begin, a user may submit an SQL request that is routed to the parser 205. As illustrated in the flowchart of FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315).

Finally, the parser 205 runs an Optimizer (block 320) that generates and selects an optimal query execution plan (e.g., the least expensive plan) comprised of one or more steps to perform the request. In one embodiment of the present invention, the Optimizer 320 includes performance information, such as actual cost information or intermediate results, when developing an optimal plan to perform the request, as described in more detail below.

Once a query execution plan is selected, it is scheduled for execution by the DBS 100. The dispatch function 210 is performed by a number of the components of the DBS 100 working together, as described in more detail below, that accepts performance goals for each workload as inputs and dynamically adjusts its own performance, such as by allocating DBS 100 resources and controlling the flow of workloads. For example, adjusting how weights are assigned to resources modifies the way access to the CPU, disk and memory are allocated among requests. Given performance objectives for each workload and the fact that the workloads may interfere with each other's performance through competition for shared resources, the DBS 100 may find a performance setting that achieves one workload's goal but makes it difficult to achieve another workload's goal.

The performance goals for each workload will vary widely as well, and may or may not be related to their resource demands. For example, two workloads that execute the same application and DBS 100 code could have differing performance goals simply because they were submitted from different departments in an organization. Conversely, even though two workloads have similar performance objectives, they may have very different resource demands.

“Closed-Loop” Workload Management Architecture

The DBS 100 includes a “closed-loop” workload management architecture capable of satisfying a set of workload-specific goals. In other words, the system is a goal-oriented workload management system capable of supporting complex workloads and capable of self-adjusting to various types of workloads. The workload management system is generally referred to as the Teradata Active System Management (TASM).

The system's operation has four major phases: 1) assigning a set of incoming request characteristics to workload groups, assigning the workload groups to priority classes, and assigning goals (called Service Level Goals or SLGs) to the workload groups; 2) monitoring the execution of the workload groups against their goals; 3) regulating (adjusting and managing) the workload flow and priorities to achieve the SLGs; and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (DBA).

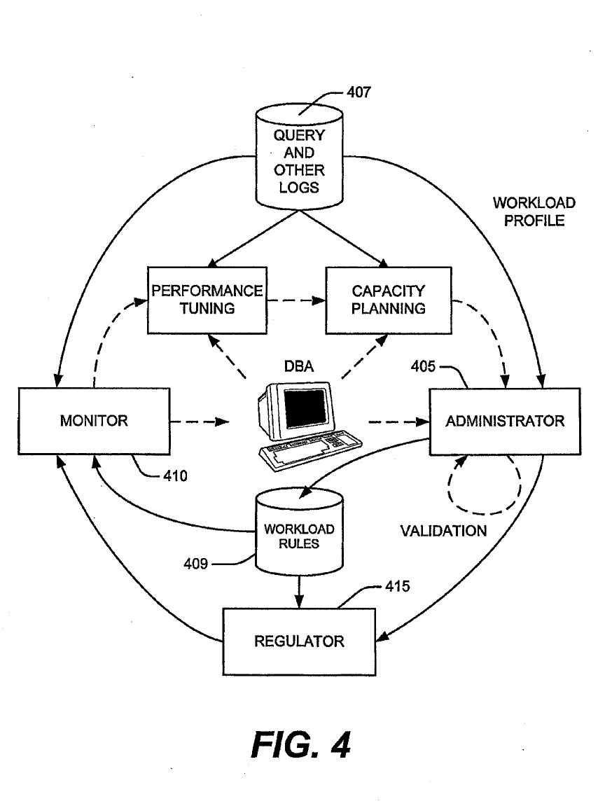

The system includes the following components (illustrated in FIG. 4):

1) Administrator (block 405): This component provides a GUI to define workloads and their SLGs and other workload management requirements. The administrator 405 accesses data in logs 407 associated with the system, including a database query log (DBQL), and receives capacity planning and performance tuning inputs as discussed above. The administrator 405 is a primary interface for the DBA. The administrator also establishes workload rules 409, which are accessed and used by other elements of the system.

2) Monitor (block 410): This component provides a top level dashboard view, and the ability to drill down to various details of workload group performance, such as aggregate execution time, execution time by request, aggregate resource consumption, resource consumption by request, etc. Such data is stored in the query log and other logs 407 available to the monitor. The monitor also includes processes that initiate the performance improvement mechanisms listed above and processes that provide long term trend reporting, which may include providing performance improvement recommendations. Some of the monitor functionality may be performed by the regulator, which is described in the next paragraph.

3) Regulator (block 415): This component dynamically adjusts system settings and/or projects performance issues and either alerts the DBA or user to take action, for example, by communication through the monitor, which is capable of providing alerts, or through the exception log, providing a way for applications and their users to become aware of, and take action on, regulator actions. Alternatively, the regulator 415 can automatically take action by deferring requests or executing requests with the appropriate priority to yield the best solution given requirements defined by the administrator (block 405). The regulator 415 may also use a set of open application programming interfaces (APIs) to access and monitor global memory partitions.

The workload management administrator (block 405), or “administrator,” is responsible for determining (i.e., recommending) the appropriate application settings based on SLGs. Such activities as setting weights, managing active work tasks and changes to any and all options will be automatic and taken out of the hands of the DBA. The user will be masked from all complexity involved in setting up the priority scheduler, and be freed to address the business issues around it.

Workload Management Administrator

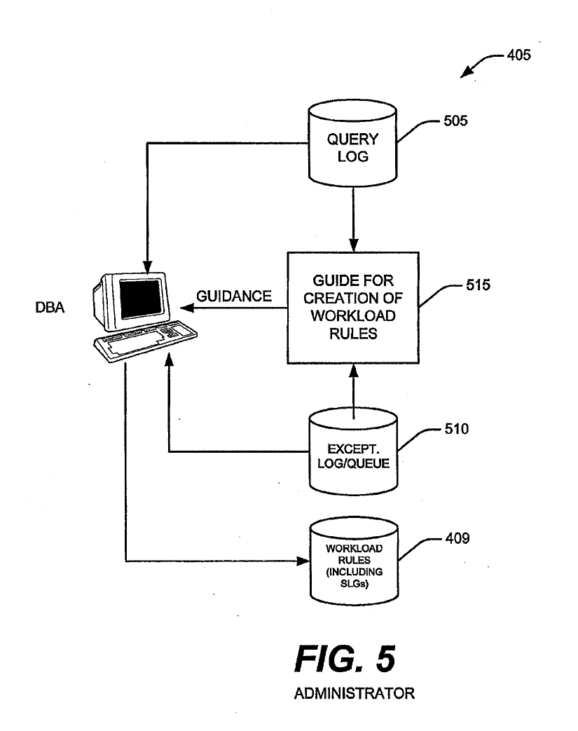

As shown in FIG. 5, the workload management administrator (block 405) allows the DBA to establish workload rules, including SLGs, which are stored in a storage facility 409, accessible to the other components of the system. The DBA has access to a query log 505, which stores the steps performed by the DBS 100 in executing a request along with database statistics associated with the various steps, and an exception log/queue 510, which contains records of the system's deviations from the SLGs established by the administrator. With these resources, the DBA can examine past performance and establish SLGs that are reasonable in light of the available system resources. In addition, the system provides a guide for creation of workload rules 515 which guides the DBA in establishing the workload rules 409. The guide accesses the query log 505 and the exception log/queue 510 in providing its guidance to the DBA.

The administrator assists the DBA in:

a) Establishing rules for dividing requests into candidate workload groups, and creating workload group definitions. Requests with similar characteristics (users, application, table, resource requirement, etc) are assigned to the same workload group. The system supports the possibility of having more than one workload group with similar system response requirements.

b) Refining the workload group definitions and defining SLGs for each workload group. The system provides guidance to the DBA for response time and/or arrival rate threshold setting by summarizing response time and arrival rate history per workload group definition versus resource utilization levels, which it extracts from the query log (from data stored by the regulator, as described below), allowing the DBA to know the current response time and arrival rate patterns. The DBA can then cross-compare those patterns to satisfaction levels or business requirements, if known, to derive an appropriate response time and arrival rate threshold setting, i.e., an appropriate SLG. After the administrator specifies the SLGs, the system automatically generates the appropriate resource allocation settings. These SLG requirements are distributed to the rest of the system as workload rules.

c) Optionally, establishing priority classes and assigning workload groups to the classes. Workload groups with similar performance requirements are assigned to the same class.

d) Providing proactive feedback (i.e., validation) to the DBA regarding the workload groups and their SLG assignments prior to execution to better assure that the current assignments can be met, i.e., that the SLG assignments as defined and potentially modified by the DBA represent realistic goals. The DBA has the option to refine workload group definitions and SLG assignments as a result of that feedback.

Internal Monitoring and Regulating

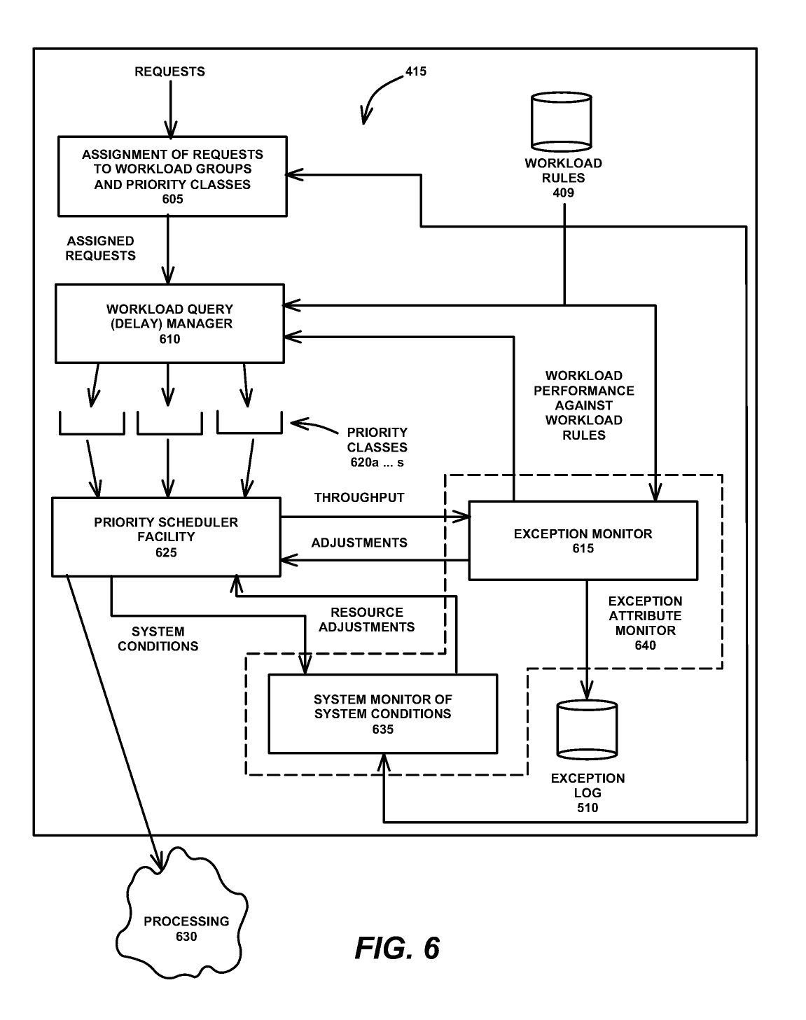

The internal monitoring and regulating component (regulator 415), illustrated in more detail in FIG. 6, accomplishes its objective by dynamically monitoring the workload characteristics (defined by the administrator) using workload rules or other heuristics based on past and current performance of the system that guide feedback mechanisms. It does this before the request begins execution and at periodic intervals during query execution. Prior to query execution, an incoming request is examined to determine in which workload group it belongs, based on criteria as described in more detail below.

Concurrency or arrival rate levels, i.e., the numbers of concurrent executing queries from each workload group, are monitored or the rate at which they have been arriving. If current workload group levels are above an administrator-defined threshold, a request in that workload group waits in a queue prior to execution until the level subsides below the defined threshold.

Query execution requests currently being executed are monitored to determine if they still meet the criteria of belonging in a particular workload group by comparing request execution characteristics to a set of exception conditions. If the result suggests that a request violates the rules associated with a workload group, an action is taken to move the request to another workload group or to abort it, and/or alert on or log the situation with potential follow-up actions as a result of detecting the situation.

Current response times and throughput of each workload group are also monitored dynamically to determine if they are meeting SLGs. A resource weight allocation for each performance group can be automatically adjusted to better enable meeting SLGs using another set of heuristics described with respect to FIG. 6.

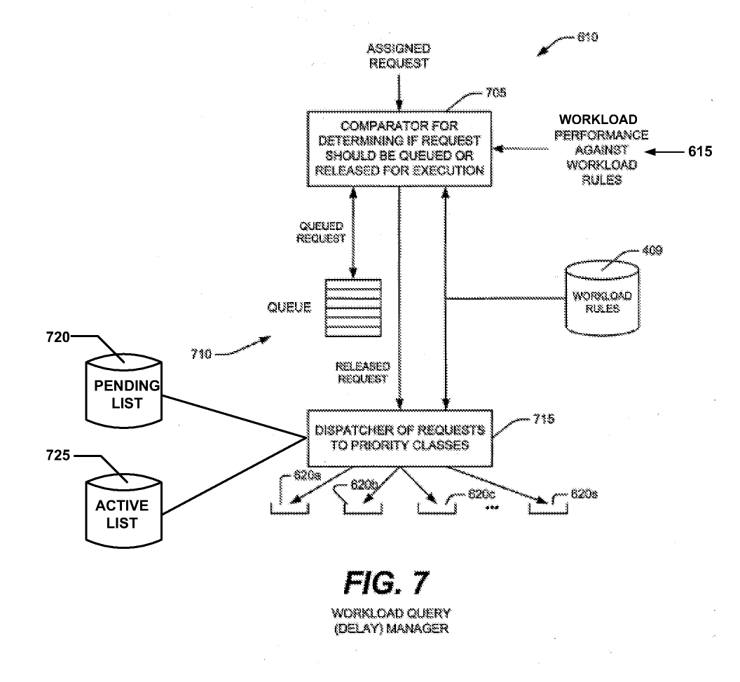

As shown in FIG. 6, the regulator 415 receives one or more requests, each of which is assigned by an assignment process (block 605) to a workload group and, optionally, a priority class, in accordance with the workload rules 409. The assigned requests are passed to a workload query (delay) manager 610, which is described in more detail with respect to FIG. 7. The regulator 415 includes an exception monitor 615 for detecting workload exceptions, which are recorded in a log 510.

In general, the workload query (delay) manager 610 monitors the workload performance from the exception monitor 615, as compared to the workload rules 409, and either allows the request to be executed immediately or places it in a queue for later execution, as described below, when predetermined conditions are met.

If the request is to be executed immediately, the workload query (delay) manager 610 places the requests in buckets 620_{a . . . s} corresponding to the priority classes to which the requests were assigned by the administrator 405. A request processor function performed under control of a priority scheduler facility (PSF) 625 selects queries from the priority class buckets 620_{a . . . s}, in an order determined by the priority associated with each of the buckets 620_{a . . . s}, and executes it, as represented by the processing block 630 on FIG. 6.

The PSF 625 also monitors the request processing and reports throughput information, for example, for each request and for each workgroup, to the exception monitor 615. Also included is a system condition monitor 635, which is provided to detect system conditions, such as node failures. The system condition monitor 635 provides the ability to dynamically monitor and regulate critical resources globally. The exception monitor 615 and system monitor 635 collectively define an exception attribute monitor 640.

The exception monitor 615 compares the throughput with the workload rules 409 and stores any exceptions (e.g., throughput deviations from the workload rules) in the exception log/queue 510. In addition, the exception monitor 615 provides system resource allocation adjustments to the PSF 625, which adjusts system resource allocation accordingly, e.g., by adjusting the priority scheduler weights. Further, the exception monitor 615 provides data regarding the workgroup performance against workload rules to the workload query (delay) manager 610, which uses the data to determine whether to delay incoming requests, depending on the workload group to which the request is assigned.

As can be seen in FIG. 6, the system provides a plurality of feedback loops. A first feedback loop includes the PSF 625 and the exception monitor 615. In this first feedback loop, the system monitors, on a short-term basis, the execution of requests to detect deviations greater than a short-term threshold from the defined service level for the workload group to which the requests were defined. If such deviations are detected, the DBS 100 is adjusted, e.g., by adjusting the assignment of system resources to workload groups.

A second feedback loop includes the workload query (delay) manager 610, the PSF 625 and the exception monitor 615. In this second feedback loop, the DBS 100 monitors, on a long-term basis, to detect deviations from the expected level of service greater than a long-term threshold. If it does, the DBS 100 adjusts the execution of requests, e.g., by delaying, swapping out or aborting requests, to better provide the expected level of service.

Workload Query (Delay) Manager

The workload query (delay) manager 610, shown in greater detail in FIG. 7, receives an assigned request as an input. A comparator 705 determines if the request should be queued or released for execution. It does this by determining the workload group assignment for the request and comparing that workload performance against the workload rules, provided by the exception monitor 615. For example, the comparator 705 may examine the concurrency level of requests being executed under the workload group to which the request is assigned. Further, the comparator 705 may compare the workload performance against other workload rules.

If the comparator 705 determines that the request should not be executed, it places the request in a queue 710 along with any other requests for which execution has been delayed. The comparator 705 continues to monitor the workload performance against the workload rules and when it reaches an acceptable level, it extracts the request from the queue 710 and releases the request for execution. In some cases, it is not necessary for the request to be stored in the queue 710 to wait for workload performance to reach a particular level, in which case it is released immediately for execution.

Once a request is released for execution it is dispatched by dispatcher 715 to priority class buckets 620_{a . . . s}, where it will await retrieval and processing 630 by one of a series of AMP Worker Tasks (AWTs) within processing block 630. An AWT is a thread/task that runs inside of each virtual AMP. An AWT is generally utilized to process requests/queries from users, but may also be triggered or used by internal database software routines, such as deadlock detection.

The exception monitor 615, receives throughput information from the AWT, which it then provides to the comparator 705 as the workload performance against workload rules 409. The comparator 705 compares the received throughput information to the workload rules 409 and logs any deviations that it finds in the exception log/queue 510. It also generates the workload performance against workload rules information that is provided to the workload query (delay) manager 610.

Pre-allocated AWTs are assigned to each AMP and work on a queue system. That is, each AWT waits for work to arrive, performs the work, and then returns to the queue and waits for more work. Due to their stateless condition, AWTs respond quickly to a variety of database execution needs. At the same time, AWTs serve to limit the number of active processes performing database work within each AMP at any point in time. In other words, AWTs play the role of both expeditor and governor of requests/queries.

AWTs are one of several resources that support the parallel performance architecture within the DBS 100. AWTs are of a finite number, with a limited number available to perform new work on the system. This finite number is an orchestrated part of the internal work flow management in the DBS 100. Reserving a special set of reserve pools for single and few-AMP queries may be beneficial for active data warehouse applications, but only after establishing a need exists. Understanding and appreciating the role of AWTs, both in their availability and their scarcity, leads to the need for a more pro-active management of AWTs and their usage.

AWTs are execution threads that do the work of executing a query step, once the step is dispatched to the AMP. They also pick up the work of spawned processes, and of internal tasks such as error logging or aborts. Not being tied to a particular session or transaction, AWTs are anonymous and immediately reusable and are able to take advantage of any of the CPUs. Both AMPs and AWTs have equal access to any CPU on the node. A fixed number of AWTs are pre-allocated at startup for each AMP in the configuration, with the default number being 80. All of the allocated AWTs can be active at the same time, sharing the CPUs and memory on the node.

When a query step is sent to an AMP, that step acquires a worker task from the pool of available AWTs. All of the information and context needed to perform the database work is contained within the query step. Once the step is complete, the AWT is returned to the pool. If all AWTs are busy at the time the message containing the new step arrives, then the message will wait in a queue until an AWT is free. Position in the queue is based first on work type, and secondarily on priority, which is carried within the message header. Priority is based on the relative weight that is established for the PSF 625 allocation group that controls the query step. Too much work can flood the best of databases. Consequently, all database systems have built-in mechanisms to monitor and manage the flow of work in a system. In a parallel database system like the DBS 100, flow control becomes even more pressing, as balance is only sustained when all parallel units are getting their fair portion of resources.

The DBS 100 is able to operate near the resource limits without exhausting any of them by applying control over the flow of work at the lowest possible level in the system. Each AMP monitors its own utilization of critical resources, AWTs being one. If no AWTs are available, it places the incoming messages on a queue. If messages waiting in the queue for an AWT reach a threshold value, further message delivery is throttled for that AMP, allowing work already underway to complete. Other AMPs continue to work as usual.

Intelligent Query Dispatching

In one embodiment, the DBS 100 implements various improvements to the Sync Scan performance optimization technique described above, wherein concurrent requests performing similar eligible table scans share physical I/Os to the data storage facilities 120_{1 . . . N} storing the rows of the table. As noted above, a query execution plan comprised of one or more steps performs the request. In this embodiment, one or more of the steps performs a table scan, and it is these steps that are subject to the intelligent query dispatching of the present invention.

This implementation of the Sync Scan does not require two or more synchronized scans to read their shared data linearly from beginning to end. Instead, a second (or third, fourth, etc.) scan can join a first scan already in progress and thus share the physical I/Os performed by the first scan. Similarly, the first scan can share the physical I/Os performed by the second scan.

Data blocks read during the physical I/Os are cached in memory to allow a plurality of different scans with the same or different row processing speeds to perform logical I/Os to the data blocks cached in the memory at the same or different times, rather than requiring the plurality of different scans to perform physical I/Os to the data storage facilities 120_{1 . . . N}, so long as the desired data blocks are already cached in memory.

Moreover, this implementation of the Sync Scan is applicable to both full table scans and partial table scans. An example of a partial table scan is to scan one or more partitions of a table that is physical partitioned across multiple data storage facilities 120_{1 . . . N}, but not scan all of the partitions. Instead, only the necessary subset of partitions need to be scanned, and only physical I/Os to those to the data storage facilities 120_{1 . . . N} are shared.

The present invention makes the workload query (delay) manager 610 aware of steps of query execution plans that are eligible for Sync Scan, and coordinates the dispatching of such steps among multiple active requests, such that the potential for synchronization is maximized between the requests. The present invention also leverages and extends this functionality into the realm of Service Level Goals.

For example, the workload query (delay) manager 610 is enhanced to delay the execution of one or more steps comprising a first scan until one or more steps comprising another similar second scan can be synchronized with the first scan. If the Sync Scan eligible steps comprising the first scan can be fully delayed until the Sync Scan eligible steps comprising the second scan are ready for dispatch at 715, the steps comprising the first and second scans can be dispatched at the same time, which maximizes the amount of potential overlap. Even in those cases where a scan cannot be fully delayed, a partial delay will often improve the chances of the second scan eventually joining the first scan already in progress, and thus improve the Sync Scan Efficiency.

Moreover, the intelligent query dispatching may be applied to more than two requests comprising more than two eligible scans. Specifically, in one embodiment, any number of eligible scans may be synchronized. Specifically, any number of eligible scans may be partially or fully delayed to maximize their overlap and thus improve Sync Scan efficiency.

To avoid potential negative response time consequences, such delays are limited to steps from requests whose estimated progress is comfortably ahead of their configured Service Level Goal (SLG). A main underlying principle of the SLG is that intentionally slowing down certain individual requests can result in better overall system utilization without negatively impacting the required response times of those requests. The solution described herein represents a specific implementation of that general principle.

Specifically, in the DBS 100, after a request has been parsed and optimized, the resulting query execution plan comprised of one or more steps is sent to the workload query (delay) manager 610, which is then responsible for coordinating their execution across multiple AMPs. By default, a given step is executed as soon as the preceding steps in its plan have completed. The present invention enhances the workload query (delay) manager 610 to become aware of all pending and running steps across all requests that represent Sync Scan eligible steps and use this knowledge to maximize their concurrency.

To accomplish this, the workload query (delay) manager 610 maintains two lists:
A “Pending” list 720 comprised of all Sync Scan eligible steps that have not yet been dispatched. This list potentially includes steps from every request currently under the control of the dispatch function 210.
An “Active” list 725 comprised of all Sync Scan eligible steps that have been dispatched and are currently executing on the AMPs.

The Pending list 720 is used to identify and organize steps that are scanning the same table and to identify situations where the delaying of a ready-to-execute step might allow another pending step to synchronize with it. The key factor used in deciding whether a step should be delayed is the estimated progress of its request relative to its SLG. If a request is comfortably ahead of its SLG, the step will be delayed if another Sync Scan eligible step exists on the Pending list 720; otherwise, the step is dispatched for immediate execution. When two or more pending and delayed scans on the same table become ready for execution, the dispatcher 715 issues the two or more steps simultaneously to the AMPs. The elapsed time that a given delayed step is willing to wait (a factor of its progress and SLG) is recorded in the delayed step and the dispatcher 715 immediately dispatches it upon the wait time expiring. Once the pending scan that was previously being waited upon becomes ready, it too will immediately execute, unless yet another scan on the same table exists on the Pending list 720.

Upon execution of each Sync Scan eligible scan step (both delayed and non-delayed) the step is added to the Active list 725 and removed from the Pending list 720. The dispatcher 715 uses the Active list 725 to alternatively consider joining another already running scan rather than waiting for another pending scan as described previously. The decision of whether to join a scan already progress is based on the estimated percent remaining in the running scan, which, in turn, requires the use of a progress estimator function. In general, the dispatcher 715 will prefer to join a running scan except in the case where the scan in progress is nearly complete. In such cases, it is assumed that the amount of overlap is minimal in which case waiting for another pending scan is more efficient.

Consequently, the present invention provides the following advantages:
Improves overall system performance and shared resource usage without impacting the required performance of individual requests.
Complements traditional query scheduling features such as the Priority Scheduler Facility 625 that focus on the assignment of CPU resources.
Can be implemented with straightforward extensions to workload query (delay) manager 610.

### Logic of the Preferred Embodiment

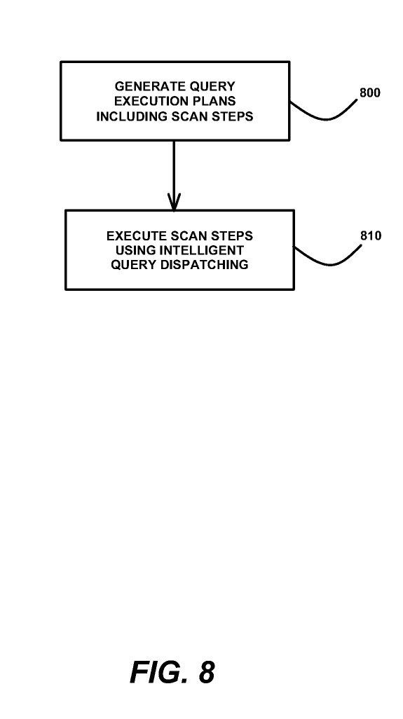

FIG. 8 is a flowchart that further illustrates the logic performed according to the preferred embodiment of the present invention. Specifically, FIG. 8 illustrates the steps and functions performed by the DBS 100 during intelligent query dispatching, as described above.

Block 800 represents the DBS 100 generating first and second query execution plans for first and second requests, wherein the first and second query execution plans are each comprised of one or more steps that scan a specified table in a database stored on the DBS 100 in order to retrieve data from the table.

Block 810 represents the DBS 100 executing the first and second query execution plans, wherein intelligent query dispatching is performed on the steps of the first and second query execution plans to ensure that the steps share the data retrieved from the table and cached in memory. Note that the steps of the second query execution plan may access the data cached in the memory at a location different from the steps of the first query execution plan. Moreover, the steps of the second query execution plan may access the data cached in the memory at a processing speed different from the steps of the first query execution plan.

The intelligent query dispatching performed in Block 810 coordinates execution of the steps of the first and second query execution plans so that the steps execute concurrently. Specifically, the intelligent query dispatching delays the steps of the first or second query execution plans in order to coordinate the execution of the steps of the first and second query execution plans. In one embodiment, the intelligent query dispatching may fully delay the steps of the first or second query execution plans, so that the steps of the first and second query execution plans begin execution at substantially the same time. In another embodiment, the intelligent query dispatching may partially delay the steps of the first or second query execution plans, so that the steps of the first and second query execution plans overlap during execution. Generally, the intelligent query dispatching may delay the steps of the first or second query execution plans, so long as such delays do not negatively affect the response time for the first or second requests.

Moreover, although the steps of FIG. 8 are described in the context of two query execution plans, the intelligent query dispatching of the present invention may be performed for more than two query execution plans. Indeed, any number of query execution plans may be eligible for Sync Scan, and thus may share the data retrieved from a table and cached in memory, according to the preferred embodiment of the present invention.

### CONCLUSION

Thus, the present invention provides a number of advantages over the prior art. First, the present invention maximizes the overall effectiveness and efficiency of Sync Scans. Moreover, the present invention does not limit or change the types of optimizations previously performed on queries, but does significantly improve the execution of such queries. Finally, the present invention leverages and co-exists with existing solutions to solve the problem at hand.

Consequently, the present invention provides a major step forward in improving the quality of query optimization. In addition, the present invention provides greater run-time and real-time awareness in query optimization as compared to prior art query optimization techniques.

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for optimizing execution of database queries in a computer system, comprising:
(a) generating, in the computer system, first and second query execution plans for first and second requests, wherein the first and second query execution plans are each comprised of one or more steps that scan a specified table in a database stored on the computer system in order to retrieve data from the table; and
(b) executing, in the computer system, the first and second query execution plans, wherein intelligent query dispatching is performed on the steps of the first and second query execution plans to ensure that the steps share the data retrieved from the table and cached in memory.

2. The method of claim 1, wherein the steps of the second query execution plan access the data cached in the memory at a location different from the steps of the first query execution plan.

3. The method of claim 1, wherein the steps of the second query execution plan access the data cached in the memory at a processing speed different from the steps of the first query execution plan.

4. The method of claim 1, wherein the intelligent query dispatching coordinates execution of the steps of the first and second query execution plans so that the steps execute concurrently.

5. The method of claim 4, wherein the intelligent query dispatching delays the steps of the first or second query execution plans in order to coordinate the execution of the steps of the first and second query execution plans.

6. The method of claim 5, wherein the intelligent query dispatching fully delays the steps of the first or second query execution plans, so that the steps of the first and second query execution plans begin execution at substantially the same time.

7. The method of claim 5, wherein the intelligent query dispatching partially delays the steps of the first or second query execution plans, so that the steps of the first and second query execution plans overlap during execution.

8. The method of claim 5, wherein the intelligent query dispatching delays the steps of the first or second query execution plans without negatively affecting a response time for the first or second requests.

9. The method of claim 1, wherein the intelligent query dispatching is performed using a pending list comprised of the steps that have not yet been dispatched and an active list comprised of the steps that are currently executing.

10. The method of claim 1, wherein the intelligent query dispatching is performed for more than two query execution plans.

11. A computer-implemented apparatus for optimizing execution of database queries in a computer system, comprising:
(a) means, performed by the computer system, for generating first and second query execution plans for first and second requests, wherein the first and second query execution plans are each comprised of one or more steps that scan a specified table in a database stored on the computer system in order to retrieve data from the table; and
(b) means, performed by the computer system, for executing the first and second query execution plans, wherein intelligent query dispatching is performed on the steps of the first and second query execution plans to ensure that the steps share the data retrieved from the table and cached in memory.

12. An article of manufacture comprising one or more storage devices tangibly embodying instructions that, when executed by a computer system, result in the computer system performing a method for optimizing execution of database queries in the computer system, the method comprising:
(a) generating, in the computer system, first and second query execution plans for first and second requests, wherein the first and second query execution plans are each comprised of one or more steps that scan a specified table in a database stored on the computer system in order to retrieve data from the table; and
(b) executing, in the computer system, the first and second query execution plans, wherein intelligent query dispatching is performed on the steps of the first and second query execution plans to ensure that the steps share the data retrieved from the table and cached in memory.
